(19) United States
(12) Patent Application Publication
(10) Pub. No.: US 2021/0264737 A1
(43) Pub. Date: Aug. 26, 2021

(54) MODIFIED VERSION OF BLACKJACK GAME

(71) Applicant: DNF24 SRL, San Giovanni Teatino (CH) (IT)

(72) Inventor: Marcello DIODATO, Pescara (IT)

(21) Appl. No.: 16/801,754

(22) Filed: Feb. 26, 2020

(51) Int. Cl. G07F 17/32

(52) U.S. Cl. CPC G07F 17/3293; G07F 17/326; G07F 17/322

(57) ABSTRACT

Described is a method for playing a card game, in particular a modified version of the game of Blackjack between a banker and at least one player, wherein a banker shuffles at least one pack of standard type playing cards with fifty-two cards and wherein the players place a bet on a game table in a space allocated for the bets relative to an expected score made by the banker. The banker draws two cards for him/herself, the banker stops or draws other cards for him/herself following the rules of Blackjack and, adding up the values of the relative cards obtains a score and, depending on the score made by the banker, each player loses any bet or wins the bet, thereby obtaining corresponding winnings.

### BACKGROUND OF THE INVENTION

This invention relates to a method and a table for playing a card game, in particular a modified version of the Blackjack game.

As is known, the game of Blackjack can use one or more packs of fifty-two playing cards formed by thirteen playing cards for each of the four suits (hearts, clubs, diamonds, spades) made up as follows: an ace, nine cards numbered in increasing order from “2” to “10”, a jack, a queen and a king. The ace is worth either one or eleven points, as chosen, determining the most favourable score, the court cards are worth ten points each whilst the numbered cards are worth their face value.

The table generally has the shape of a semicircle, where the banker sits on one side whilst seven players can sit in front. The players place their bets in the spaces provided for the bets.

The banker proceeds from left to right and distributes one card face up in each betting position, giving the last card to him/herself (that is to say, to the bank); the banker then places a second round of cards face up, one for each position in the same order as before, assigning the last card face down.

After seeing their own playing cards, each player can decide whether to “stick” or “twist”, in accordance with the following rules:
when the score reached is less than or equal to “11”, the player must take at least one more card;
when the score reached is equal to “21”, the player must stop;
when the score reached is greater than “21”, the player “busts” and can no longer play in that hand;
in all other cases, the player is free to take another card or not.

When all the players have played their game, the banker must end the game by applying the rules of the bank:
if the bank has a score of up to “16”, the banker takes one or more cards to exceed it;
if the bank reaches or exceeds a score of “17”, the banker stops;
if the bank exceeds “21”, the banker's hand has lost and all the remaining bets are paid up.

The banker, after establishing all the scores, compares them with his/her own score, paying for the combinations of scores higher than his/her own, collecting the bets relating to scores lower than his/her own and not touching equal scores.

In the counting up of the scores there is a combination, the so-called “Blackjack”, which is obtained when the initial playing cards are an ace and a court card or an ace and a “10”. This combination beats “21” and can be equalled only if the banker also makes a “Blackjack”. With a “Blackjack” the value of the ace is always “11” and it is therefore not possible to ask for other cards.

As mentioned above, if a player “busts” or loses, his/her game ends and he/she does not take part until the next hand, after completion of the hands of the other players, when it all starts again. The same dynamics of poor attention and participation in the game can also occur in the case of a win.

The purpose of the invention is therefore to provide a method for playing a card game, in particular a modified version of Blackjack, which allows a player to be more active or interested in the game even in the case of a “bust”, losing to the bank or a win if playing with several players.

The technical purpose of the invention is also to provide a table for playing the above-mentioned method of the game.

### SUMMARY OF THE INVENTION

According to the method for playing a card game, in particular a modified version of the game of Blackjack, a banker shuffles at least one pack of standard type playing cards with fifty-two cards and the players place a bet on a game table in a space allocated for the bets relative to an expected score made by the banker.

Preferably, the supposed score on which to place the bet can be selected between eleven values of between “17” and “26” and a score of Blackjack.

Preferably, the supposed score on which to place the bet can be selected between values of between “22” and “26”.

At this point, the banker draws two cards for him/herself and stops or draws other cards for him/herself following the rules of Blackjack, adding the values of the relative own cards to obtain a score.

Depending on the score made by the banker, each player loses any bet or wins the bet, thereby obtaining corresponding winnings.

Preferably, for each supposed score there is a range of winnings between a minimum value and a maximum value.

Preferably, if the bet relates to a supposed score of “17” it is possible to obtain a winnings of between a minimum of 3:1 and a maximum of 6:1. Even more preferably, the payment is 5:1.

Preferably, if the bet relates to a supposed score of “18” it is possible to obtain a winnings of between a minimum of 4:1 and a maximum of 7:1. Even more preferably, the payment is 6:1.

Preferably, if the bet relates to a supposed score of “19” it is possible to obtain a winnings of between a minimum of 4:1 and a maximum of 7:1. Even more preferably, the payment is 6:1.

Preferably, if the bet relates to a supposed score of “20” it is possible to obtain a winnings of between a minimum of 2:1 and a maximum of 5:1. Even more preferably, the payment is 4:1.

Preferably, if the bet relates to a supposed score of “21” it is possible to obtain a winnings of between a minimum of 9:1 and a maximum of 13:1. Even more preferably, the payment is 12:1.

Preferably, if the bet relates to a supposed score of “Blackjack” it is possible to obtain a winnings of between a minimum of 16:1 and a maximum of 20:1. Even more preferably, the payment is 19:1.

Preferably, if the bet relates to a supposed score of “22” it is possible to obtain a winnings of between a minimum of 10:1 and a maximum of 13:1. Even more preferably, the payment is 12:1.

Preferably, if the bet relates to a supposed score of “23” it is possible to obtain a winnings of between a minimum of 11:1 and a maximum of 14:1. Even more preferably, the payment is 13:1.

Preferably, if the bet relates to a supposed score of “24” it is possible to obtain a winnings of between a minimum of 13:1 and a maximum of 16:1. Even more preferably, the payment is 15:1.

Preferably, if the bet relates to a supposed score of “25” it is possible to obtain a winnings of between a minimum of 15:1 and a maximum of 18:1. Even more preferably, the payment is 17:1.

Preferably, if the bet relates to a supposed score of “26” it is possible to obtain a winnings of between a minimum of 18:1 and a maximum of 22:1. Even more preferably, the payment is 21:1.

The game method may be integrated in a game of Blackjack or it may be played independently of a game of Blackjack.

If the method is integrated in a game of Blackjack, the players must place a bet on a game table following the rules of the normal game of the Blackjack and the bank draws two cards for each player.

Each player makes decisions according to the rules of Blackjack until the players have lost the right to obtain more cards. The rules providing for the possibility of sticking, requesting another card or following other variations on the game of Blackjack.

The values of the two cards and of all the additional cards of the players are added together following the rules of Blackjack and the values of the cards of each player and of the bank are compared with each other following the rules of Blackjack, deciding the winning or losing of the player relative to the bet placed.

The game table for playing a card game, in particular a modified version of the game of Blackjack between a banker and at least one player, defines a supporting surface equipped with a space in which at least one player can place a bet relative to an expected score made by the banker.

Preferably, the space comprises eleven portions each defining a score on which to place the bet. The portions comprise ten portions having values of between “17” and “26” and a portion relative to the score of Blackjack.

Preferably, the supporting surface also comprises a further area in which each player can place a bet relative to the normal game of Blackjack.

### BRIEF DESCRIPTION OF DRAWINGS

FIG. 1 is a schematic view, in particular a top view, of a game table according to the invention.

FIG. 2 is a detail of the game table of FIG. 1.

FIG. 3 is a schematic view, in particular a top view, of a further embodiment of the game table.

FIG. 4 is a detail of the game table of FIG. 3.

### DESCRIPTION OF PREFERRED EMBODIMENTS

The invention relates to a method for playing a card game. In particular, the method allows a modified version of the Blackjack game to be played between a banker and at least one player. Preferably, the method comprises a game with up to a maximum of seven players in addition to the banker.

The invention also makes it possible to play further modified versions of the game of Blackjack, such as those which involve games with an unlimited number of players, which are very frequent in online casinos.

According to the method, the banker shuffles at least one pack of standard type playing cards of fifty-two cards. Preferably, the banker (or bank) can use several packs of cards.

The expression “pack of standard type playing cards” means packs consisting of thirteen playing cards for each of the four suits (hearts, clubs, diamonds, spades) comprising an ace, nine cards numbered in increasing order from “2” to “10”, a jack, a queen and a king.

Once the pack (or packs) have been shuffled, the banker can position the shuffled pack on a game table 1 in such a way that only the back of the cards is visible (thereby not showing the suit and the value of the top card).

At this point the players place a bet on the game table 1 in a space 2 allocated for the bets relative to an expected score made by the banker;

The supposed score on which to place the bet can be selected between ten values of between “17” and “26” and a score of Blackjack. In other words, the banker can make a score which ranges from a minimum of 17% to a maximum of “26” taking into account the possible combinations of cards.

Preferably, the supposed score on which to place the bet can be selected between values of between “22” and “26”.

In other words, according to the game method, the players can bet on the result obtained by the banker, this result being obtained by adding up the cards according to the rules of Blackjack.

In particular, the banker draws two cards for him/herself and can decide whether to stop or draw other cards for him/herself following the rules of Blackjack.

If, from the sum of the cards drawn for him/herself, the banker obtains a score up to “16”, the banker must draw one or more cards to exceed it.

If he/she reaches or exceeds a score of “17”, the banker must stop.

If he/she exceeds the result of “21”, the banker's hand is a losing hand.

For the allocation of the points, as per the rules for Blackjack, the ace is worth either one or eleven points determining the most favourable score, the court cards are worth ten points each whilst the numbered cards are worth their face value.

In the counting up of the scores there is a combination, the so-called “Blackjack”, which is obtained when the initial playing cards are an ace and a court card or an ace and a “10”.

Depending on the score made by the banker, each player loses any bet or wins the bet, thereby obtaining corresponding winnings.

For each supposed score there is a range of winnings between a minimum value and a maximum value which can change from table to table or from casino to casino.

If the bet relates to a supposed score of “17” it is possible to obtain a winnings of between a minimum of 3:1 and a maximum of 6:1. In the case of a score of “17” the payment may be 5:1

If the bet relates to a supposed score of “18” it is possible to obtain a winnings of between a minimum of 4:1 and a maximum of 7:1. In the case of a score of “18” the payment may be 6:1

If the bet relates to a supposed score of “19” it is possible to obtain a winnings of between a minimum of 4:1 and a maximum of 7:1. In the case of a score of “19” the payment may be 6:1

If the bet relates to a supposed score of “20” it is possible to obtain a winnings of between a minimum of 2:1 and a maximum of 5:1. In the case of a score of “20” the payment may be 4:1

If the bet relates to a supposed score of “21” it is possible to obtain a winnings of between a minimum of 9:1 and a maximum of 13:1. In the case of a score of “21” the payment may be 12:1

If the bet relates to a supposed score of “Blackjack” it is possible to obtain a winnings of between a minimum of 16:1 and a maximum of 20:1. In the case of a “Blackjack” score, the payment may be 19:1.

If the bet relates to a supposed score of “22” it is possible to obtain a winnings of between a minimum of 10:1 and a maximum of 13:1. In the case of a score of “22” the payment may be 12:1

If the bet relates to a supposed score of “23” it is possible to obtain a winnings of between a minimum of 11:1 and a maximum of 14:1. In the case of a score of “23” the payment may be 13:1

If the bet relates to a supposed score of “24” it is possible to obtain a winnings of between a minimum of 13:1 and a maximum of 16:1. In the case of a score of “24” the payment may be 15:1

If the bet relates to a supposed score of “25” it is possible to obtain a winnings of between a minimum of 15:1 and a maximum of 18:1. In the case of a score of “25” the payment may be 17:1

If the bet relates to a supposed score of “26” it is possible to obtain a winnings of between a minimum of 18:1 and a maximum of 22:1. In the case of a score of “26” the payment may be 21:1

The method described above is a method which can be played individually, in other words independently of that of a normal game of Blackjack.

Preferably, the bets placed by the players may be made at any time in the game before the banker starts to deal the cards to the players present at the table.

Advantageously, the game method described above makes it possible to actively involve all the players from the start to the end of the hand.

If the game method described above is integrated in a normal game of Blackjack, a game is played as described below.

Once the cards have been shuffled, the players place a bet on a game table following the rules of the normal game of Blackjack. The bet may be placed parallel to that relative to the expected score of the banker.

The bank draws two cards for each player, in particular moving from left to right dealing a first card face up and dealing the last one to him/herself and then dealing a second round of cards face up and dealing the last card to him/herself face down.

At this point, each player makes decisions according to the rules of Blackjack until the players have lost the right to obtain more cards.

The rules provide for the possibility of sticking, requesting another card or following other variations on the game of Blackjack.

The variations of the game provide for the possibility of Doubling Down, Splitting, Splitting 2 Aces and Insurance or other rules if planned.

According to the Doubling Down rule, a player may, after receiving the first two cards, irrespective of the score obtained, decide to double his/her bet. In this case, the banker places the amount received above the initial bet and deals a single card, which is arranged perpendicularly to the other two.

According to the Splitting rule, if the first two cards received are of equal value (two “3s”, two “Jacks”, a “King” and a “10” etc.) the relative player can divide them and play the game with two separate and independent hands. The banker arranges the two cards close to each other, one parallel to the other, positioning alongside the initial bet the same amount provided by the customer. If the third card received forms another pair, the player can split again by adding a further bet, always of the same value. After having split two court cards, two “10s” or a court card and “10” a player, upon receiving an ace, has the right to use it as “1” or “11” points: if he/she decides for the value of “1”, determining the total score as “11” points, he/she can request one or more cards or double down.

According to the Splitting 2 Aces rule, the banker deals a single card for each of them, arranged perpendicularly, without other gaming possibilities. If the card is a 10 or a court card, the score made is not “Blackjack” but only “21”.

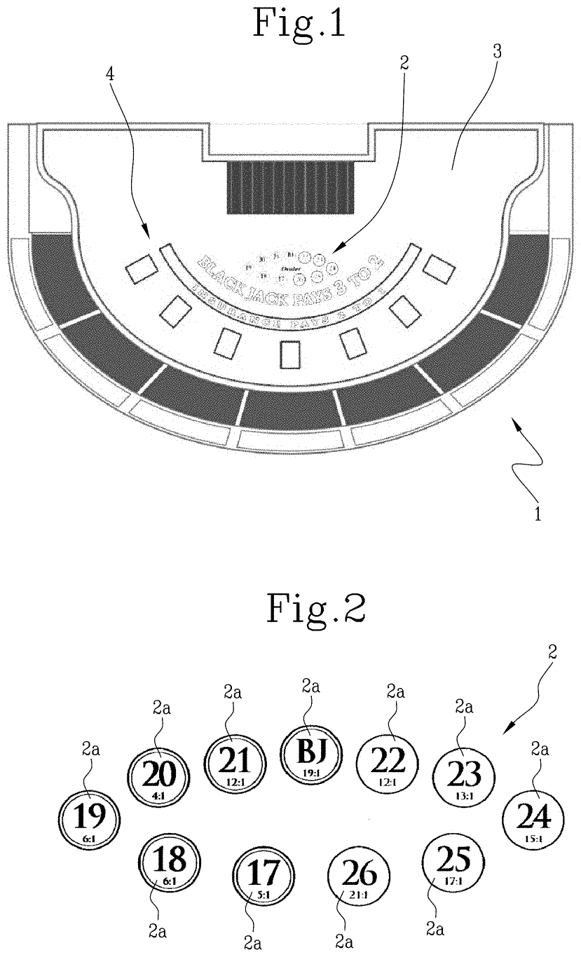

According to the Insurance rule, if the banker deals an ace as the first card, the players are given the opportunity to bet on a possible “Blackjack” made by the bank. The player who “insures” places on the line with the word “Insurance” (as shown for example in FIG. 1), in front of his/her own position, an amount in tokens with a value which cannot exceed half the initial bet. If the banker makes a “Blackjack” the Insurances are paid at 2:1 (“Blackjacks” cannot be insured, so they are drawn); all the other bets are lost. If, on the other hand, the “Blackjack” is not formed, the insurances lose immediately; so, if it is not already determined, the banker completes the hand of the bank, then simultaneously operates on each box.

The values of the two cards and of all the additional cards of the players are added together following the rules of Blackjack.

In the counting up of the scores there is a combination, the so-called “Blackjack”, which is obtained when the initial playing cards are an ace and a court card or an ace and a “10”. This combination beats “21” and can be equalled only if the banker also makes a “Blackjack”. With a “Blackjack” the value of the ace is always “11” and it is therefore not possible to ask for other cards.

The values of the cards of each player and of the bank are compared with each other following the rules of Blackjack, deciding the winning or losing of the player relative to the bet placed.

In other words, each player can win or lose relative to the hand in progress during the game of Blackjack but at the same time can win or lose relative to the previous bet placed on the expected score of the banker.

Advantageously, if all the players have lost, the banker is obliged to complete his/her game only for the purposes of the “parallel” bet relative to the expected score.

Advantageously, this game method allows each player to remain involved during the entire game. For example, if a player is the first in the round, he/she will be able to wait for the result obtained by the banker until the end in order to claim, or not, the winnings relative to the expected score.

The invention also relates to a game table 1 for playing a card game, in particular the modified version of the Blackack game between a banker and at least one player.

The game table 1 defines a supporting surface 3 equipped with a space 2 in which at least one player can place a bet relative to an expected score made by the banker.

The space 2 comprises eleven portions 2a each defining a score on which to place the bet. There are ten portions 2a and they have values of between “17” and “26” and a portion 2a relative to the score of Blackjack.

The space 2 is represented in FIG. 2 as an area in which the portions 2a are defined in the form of circles containing the score on which to place the bet and the specific payment which can be obtained in the case of a win.

As shown for example in FIG. 1, the supporting surface 3 also comprises a further area 4 in which each player can place a bet relative to the normal game of Blackjack.

Advantageously, the game table 1 described above may be used for playing a normal game of Blackjack and for playing a modified game according to the method described above independently of or parallel to a normal game of Blackjack.

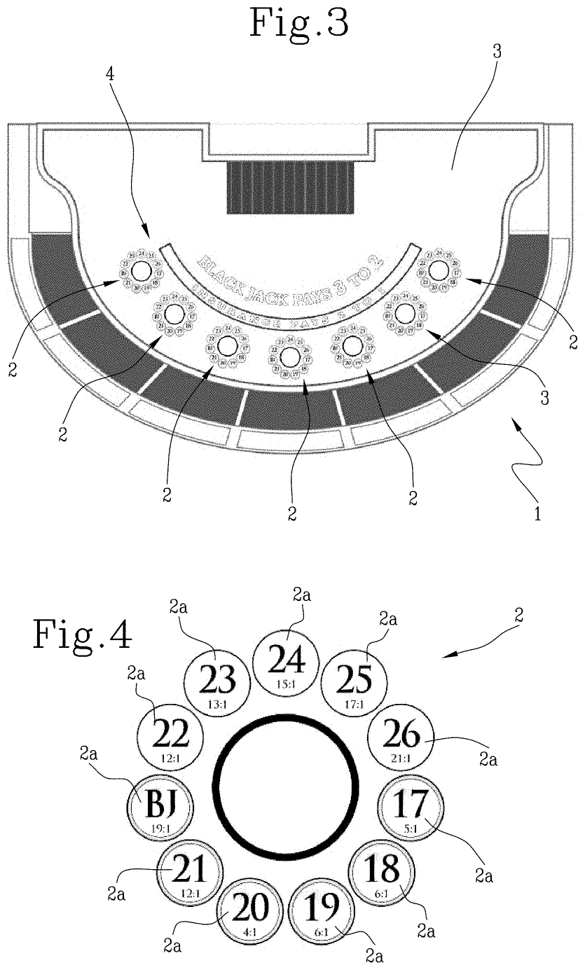

In FIGS. 3 and 4, the space 2 provided with the portions 2a is present on the supporting surface 3 with different portions of the surface associated with the players. In other words, in FIGS. 3 and 4 the table 1 is provided, in the further area 4, with a number of spaces 2 equal to the number of players who can sit at the table. Each space 2 is defined by a circle in which the players can place the bets relative to a game of Blackjack (modified or not) and by a number of portions 2a (distributed concentrically relative to the circle) with which to place the bets relative to the game method described above (according to one or more of the possible embodiments which define the different rules which can change from table to table or from casino to casino).

Advantageously, the portions 2a allow an area to be obtained in which to adequately distinguish the possible winnings and the scores on which each player is betting.

Advantageously, the invention makes it possible to provide a method for playing a card game, in particular a modified version of Blackjack, and a game table which allow a player to be more active or interested in the game even in the case of a “bust”, losing to the bank or a win if, after the relative hand, there are various players before the end of the game.

1. A method for playing a card game, in particular a modified version of the Blackjack game between a banker and at least one player, wherein:
a banker shuffles at least one pack of standard type playing cards of fifty-two cards;
the players place a bet on a game table in a space allocated for the bets relative to an expected score made by the banker;
the banker draws two cards for him/herself;
the banker stops or draws other cards for him/herself following the rules of Blackjack and adding up the values of the relative cards obtains a score;
depending on the score made by the banker, each player loses any bet or wins the bet, thereby obtaining corresponding winnings.

2. The method according to claim 1, wherein the supposed score on which to place the bet can be selected between eleven values comprising ten values of between “17” and “26” and a score of Blackjack.

3. The method according to claim 1, wherein the supposed score on which to place the bet can be selected between values of between “22” and “26”.

4. The method according to claim 1, wherein for each supposed score there is a range of winnings between a minimum value and a maximum value.

5. The method according to claim 4, wherein if the bet relates to a supposed score of “17” it is possible to obtain a winnings of between a minimum of 3:1 and a maximum of 6:1.

6. The method according to claim 4, wherein if the bet relates to a supposed score of “18” it is possible to obtain a winnings of between a minimum of 4:1 and a maximum of 7:1.

7. The method according to claim 4, wherein if the bet relates to a supposed score of “19” it is possible to obtain a winnings of between a minimum of 4:1 and a maximum of 7:1.

8. The method according to claim 4, wherein if the bet relates to a supposed score of “20” it is possible to obtain a winnings of between a minimum of 2:1 and a maximum of 5:1.

9. The method according to claim 4, wherein if the bet relates to a supposed score of “21” it is possible to obtain a winnings of between a minimum of 9:1 and a maximum of 13:1.

10. The method according to claim 4, wherein if the bet relates to a supposed score of “Blackjack” it is possible to obtain a winnings of between a minimum of 16:1 and a maximum of 20:1.

11. The method according to claim 4, wherein if the bet relates to a supposed score of “22” it is possible to obtain a winnings of between a minimum of 10:1 and a maximum of 13:1.

12. The method according to claim 4, wherein if the bet relates to a supposed score of “23” it is possible to obtain a winnings of between a minimum of 11:1 and a maximum of 14:1.

13. The method according to claim 4, wherein if the bet relates to a supposed score of “24” it is possible to obtain a winnings of between a minimum of 13:1 and a maximum of 16.1.

14. The method according to claim 4, wherein if the bet relates to a supposed score of “25” it is possible to obtain a winnings of between a minimum of 15:1 and a maximum of 18:1.

15. The method according to claim 4, wherein if the bet relates to a supposed score of “26” it is possible to obtain a winnings of between a minimum of 18:1 and a maximum of 22:1.

16. The method according to claim 1, wherein:
the players place a bet on a game table following the rules of the normal game of Blackjack;
the bank draws two cards for each player;
each player makes decisions according to the rules of Blackjack until the players have lost the right to obtain more cards, said rules providing for the possibility of sticking, requesting another card or following other variations on the game of Blackjack;
the values of the two cards and of all the additional cards of the players are added together following the rules of Blackjack;
the values of the cards of each player and of the bank are compared with each other following the rules of Blackjack, deciding the winning or losing of the player relative to the bet placed.

17. A game table for playing a card game, in particular a modified version of the game of Blackjack between a banker and at least one player, defining a supporting surface equipped with a space in which at least one player can place a bet relative to an expected score made by the banker.

18. The table according to claim 17, wherein said space comprises eleven portions each defining a score on which to place the bet, said portions comprising ten portions having values of between “17” and “26” and a portion relative to the score of Blackjack.

19. The table according to claim 17, wherein said supporting surface also comprises a further area in which each player can place a bet relative to the normal game of Blackjack.

20. The table according to claim 17, comprising a number of spaces equal to the number of players who can sit at the table.
